(19) United States
(12) Patent Application Publication
(10) Pub. No.: US 2014/0360092 A1
(43) Pub. Date: Dec. 11, 2014

(54) ARTIFICIAL PREDATOR SYSTEMS AND SUBSYSTEMS

(71) Applicant: DEAN E. COOK, JR., SOUTHBRIDGE, MA (US)

(72) Inventor: DEAN E. COOK, JR., SOUTHBRIDGE, MA (US)

(21) Appl. No.: 14/286,813

(22) Filed: May 23, 2014

Related U.S. Application Data
(60) Provisional application No. 61/831,522, filed on Jun. 5, 2013.

(51) Int. Cl. A01M 99/00; A01M 23/00; A01M 5/02; A01M 1/00; A01M 21/02; A01M 31/00

(52) U.S. Cl. CPC A01M 99/00; A01M 21/02; A01M 31/002; A01M 5/02; A01M 1/00; A01M 23/00; Y10S 901/01; Y10S 901/50
USPC 43/124; 901/1; 901/50

(57) ABSTRACT

An artificial predator is a robotic system that does two tasks at the same time by eating

An artificial predator will harvest chemical energy from the environment in which it lives by (eating) a target species. The target species is programmed into the robot. The robot uses neural nets (or similar system) for discerning what to target and what to ignore. Then the robot can convert this food into energy. After this process is completed, the robot will continue to hunt and consume its target species.

The robot would move through the ecosystem, whether it is natural or manmade. It can be trained to attack a specific target. One potential target would be a plant like a weed on a large agricultural farm. Another potential target could be a pest such as an invasive species of plant or animal. This robot can detect and destroy pests.

### BACKGROUND

### Technology Area and Problem Solving

Large scale agriculture has become plagued by herbicide resistant weeds and by pesticide resistant pests. Due to the introduction for genetically modified crops, weeds and insects have become more resistant because of evolutionary adaptations to the herbicides and pesticides designed to destroy them. This has happened faster than anyone ever imagined.

The large scale travel of persons and freight has led to the major problem of invasive species of plants and animals. Controlling these invasive species has been problematic and expensive. Large scale use of herbicides and pesticides are undesirable, dangerous, and can lead to adaptation or other unseen environmental concerns.

Because invasive species have no natural predators in their new environment; they spread uncontrollably. In the past, when natural predators have been introduced to environments, they have had disastrous results with unforeseen consequences.

### BRIEF SUMMARY OF THE INVENTION

An artificial predator is a robotic system that does two tasks at the same time by eating. By eating a desired target, it destroys that target species and gains energy to continue eating the target without stop to refuel or recharge.

An artificial predator is a robotic system that can change the balance of an ecological system. The system can be designed to destroy herbicide resistant weeds and pesticide resistant insects. It can consume invasive species of plants and pests. It would also harvest excess energy from the environment while still conserving the health of the environment.

In an ecological system, all living creatures in that system affect the system. That effect is created by any creature striving to exist, by harvesting energy from the environment in which it lives (eating). The robot will convert energy from the environment by eating a target species, much as a living creature consumes a food source. The target species is programmed into the robot using neural nets (or similar systems) for discerning what to target and what to ignore. Then the robot can convert this food into energy. After this process is completed, the robot will continue to hunt and consume its target species.

The robot would move through the ecosystem, whether it is natural or man-made. It can be trained to attack a target. One potential target would be a plant like a weed on a large agricultural farm. Another potential target could be a pest in a farmer's field such as an invasive species of plant or animal. This robot can also be used to detect and destroy pests found in a forest such as the Multiform Rose or Longhorn Beetle.

### BRIEF DESCRIPTION OF THE DRAWINGS

FIG. 1: A diagram of the flow of energy and information in the Artificial Predator Systems and Subsystems

FIG. 2: Side view drawing of micro biomass gasifier for Artificial Predator Systems

FIG. 3: Left view drawing of FIG. 2 gasifier for Artificial Predator Systems

FIG. 4: Right view drawing of FIG. 2 gasifier for Artificial Predator Systems

FIG. 5: Top view drawing of FIG. 2 gasifier for Artificial Predator Systems

FIG. 6: Drawing of micro biomass combustion version for Artificial Predator Systems

FIG. 7: Left view drawing of FIG. 6 gasifier for Artificial Predator Systems

FIG. 8: Right view drawing of FIG. 6 gasifier for Artificial Predator Systems

FIG. 9: Top view drawing of FIG. 6 gasifier for Artificial Predator Systems

FIG. 10: Side view of biomass cruncher and dewatering device for Artificial Predator Systems

FIG. 11: Front view of biomass cruncher and dewatering device for Artificial Predator Systems

FIG. 12: Side view micro oxygen concentrator

FIG. 13: Side view ¼ turn along the long axis of FIG. 12. micro oxygen concentrator

FIG. 14: Side view internet heat Nitinol muscles actuator with liquid thermo/photo heat storage. The actuator is in the full contracted state.

FIG. 15: Side view internet heat Nitinol muscles actuator with liquid thermo/photo heat storage. The actuator is in the full extended state.

FIG. 16: Side view external heat Nitinol muscles actuator with liquid thermo/photo heat storage. The actuator is in the full contracted state.

FIG. 17: Side view external heat Nitinol muscles actuator with liquid thermo/photo heat storage. The actuator is in the full extended state.

FIG. 18: Side View of thermo liquid/photo cooling chamber.

FIG. 19: Two Semiconducting polymer threads with signal enhancement FIG. 20: Two Semiconducting polymer threads with signal interference

FIG. 21: One Semiconducting polymer threads with signal enhancement and signal interference

### DETAIL DESCRIPTION OF FIGURES

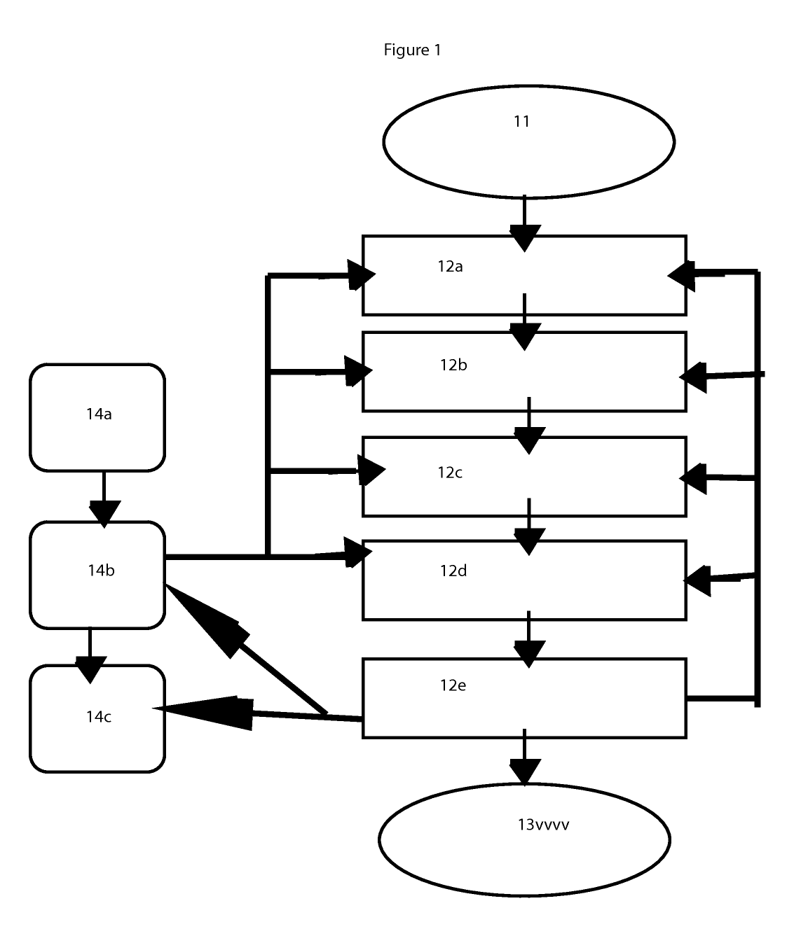

FIG. 1 Flow diagram (numbers 11-14)
11. A representation of all material outside of the Artificial Predator available for conversion into chemical energy.
12a. The end-effector needed to gather whatever the target of the Artificial Predator is. It can be a cutting device for weeds or other plants, jaw device for insects or a grinding dive for wood.
12b. A crunching and dewatering device to remove excess water to aid gasification or combustion and to insure the piece are small so they don't block the system
12c. Conversion of the biomass to heat through gasification or combustion will be dependent on the needs of the system. Gasification will be used if harnessing energy outside the system is desired.
12d. Energy will be stored into bio-gas and or heat
12e. Energy will flow back into the system for use in steps 11 to 12d
13. Energy can be moved out of the system for external uses
14a. Sensors
14b. Control process
14c. Locomotion. Artificial Predator may or may not be mobile

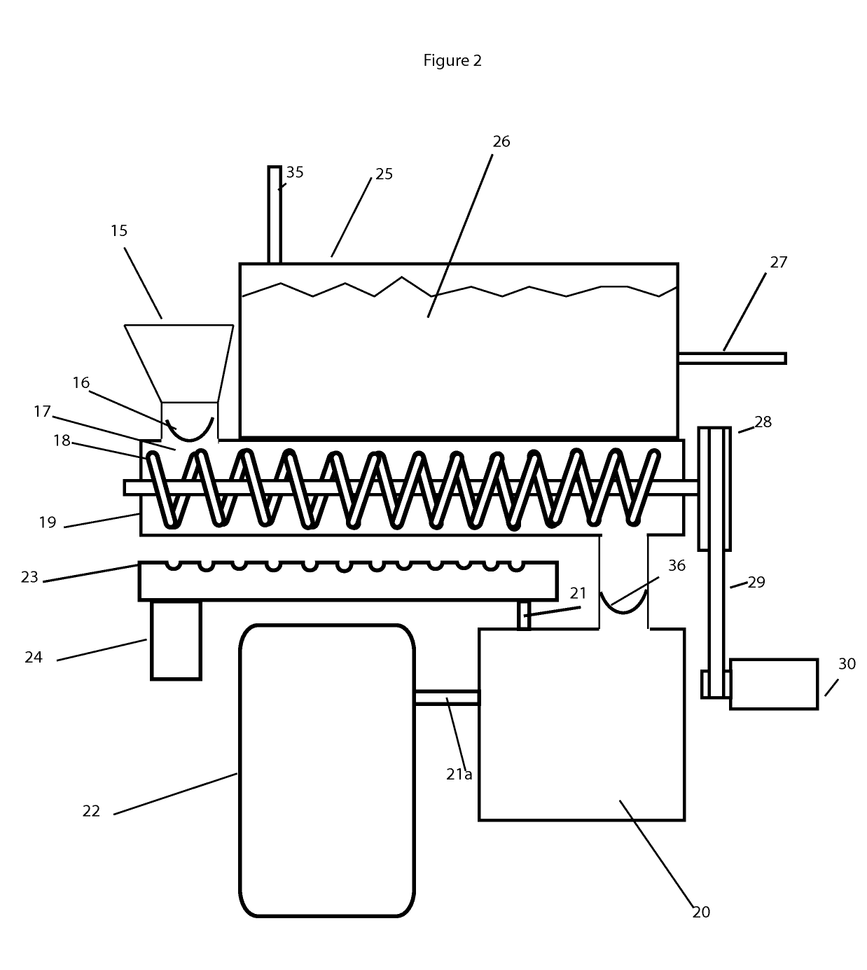

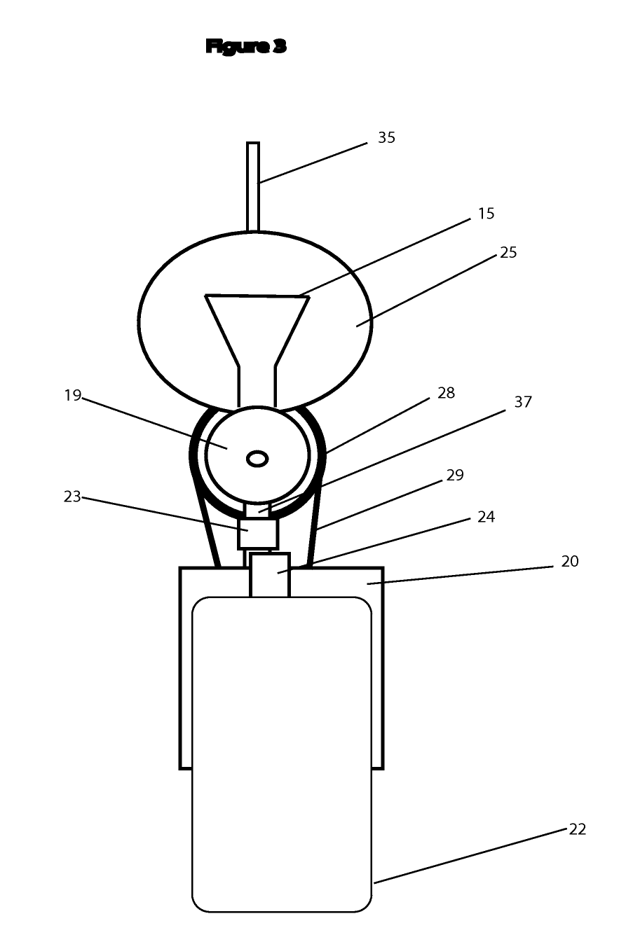

FIG. 2 Micro Gasifier (MG) 15-37
A micro gasifier system would be considered when you wish to harvest the excess energy not needed to run the robot for human use.
The micro-gasifier digestion system is a way of converting biomass either plants or animal based, into energy for a robot.
15. The biomass is loaded into a hopper from the crushing rollers.
16. At the bottom of the hopper is a valve the will allow biomass to enter the gasifier chamber and block the back flow of bio-gas.
17. A hole in the top of the gasifier chamber give access to the gasifier chamber from the bottom of the hopper.
18. An auger moves the biomass through the gasifier chamber as the material decomposes. The auger is held on one end though a small hole in the gasifier chamber and turned on the other end with a pulley.
19. The gasifier chamber is a cylinder made out of metal or other heat conducting materials.
20. A container for collecting the bio-char after biomass has been gasified. It is connected to a hole the bottom of the gasifier chamber allowing bio-char and bio-gas out.
21. A tube connecting the bio-char collector to the bio-gas burner, allows bio-gas to be combusted to continue the reaction in the gasifier chamber.
21a. A tube connecting the bio-char collector to the bio-gas storage tank.
22. A collection chamber for excess bio-gas and to help maintain pressure in the system. It also stores gas for re-starting the process in between operations.
23. A bio-gas burner is used to provide heat to gasify the biomass.
24. A liquid butane fuel with a sparker will be use to start the bio-gas burner.
25. A tank made of heat conducting materials is connected to the top of gasifier chamber allowing heat to flow into the liquid in the tank.
26. The liquid contains a concentration of Cis and Trans Azo compound.
27. A tube connecting the heating tank to the optical cooling chamber
28. A pulley to move the auger
29. A belt to move the pulley
30. A small motor
35. Tube to return flow from the optical cooling chamber
36. A valve the will allow biomass to enter the bio-char chamber and block the back flow of bio-gas
37. A connect between the gasifation chamber to the bio-char chamber

FIG. 3
35. Tube returns flow from the optical cooling chamber.
15. Biomass is loaded into a hopper from the crushing rollers.
25. A tank made of heat conducting materials is connected to the top of gasifier chamber allowing heat to flow into the liquid in the tank.
28. A pulley to move the auger
23. A bio-gas burner is used to provide heat to gasify the biomass.
29. A belt to move the pulley
24. A device with liquid butane fuel with a sparker will be use to start the bio-gas burner.
37. A connection between the gasification chamber to the boichar chamber
20. A container for collecting the biochar after biomass has been gasified. It is connected to a hole at the bottom of the gasifier chamber allowing biochar and bio-gas out.
30. A small motor
22. A collection chamber of excess bio-gas and to help maintain pressure and store gas for starting the process in between operations.

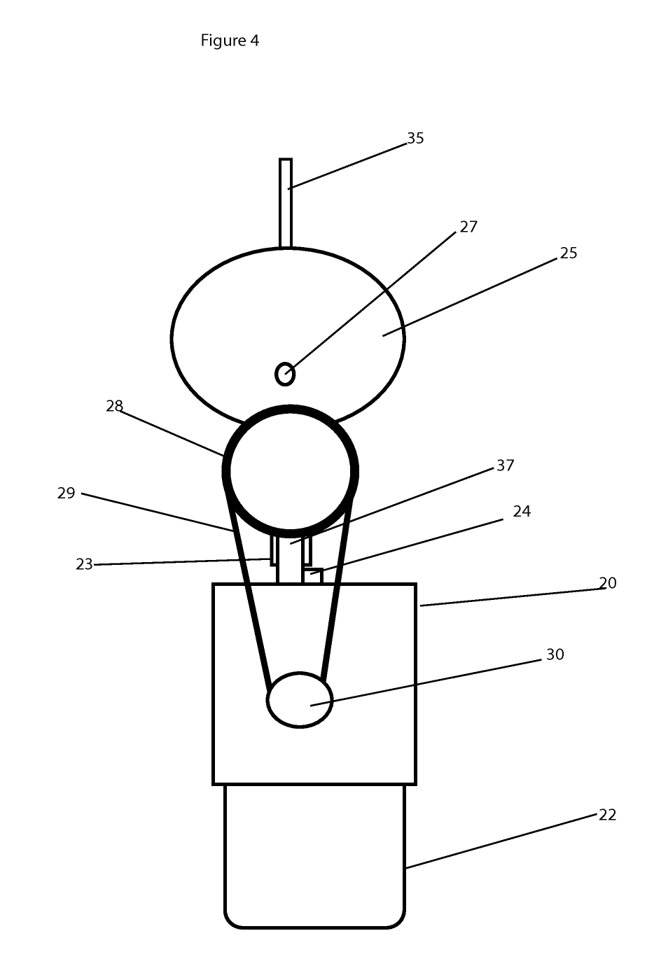

FIG. 4
19. The gasifier chamber is a cylinder made out of metal or other heat conducting materials.
35. Tube returns flow from the optical cooling chamber.
25. A tank made of heat conducting material is connected to the top of gasifier chamber allowing heat to flow into the liquid in the tank.
27. A tube connecting the heating tank to the optical cooling chamber.
28. A pulley to move the auger
23. A bio burner is used to provide heat to gasify the biomass.
29. A belt to move the pulley
24. A device with liquid butane fuel with a sparker will be used to start the bio-gas burner.
37. A connection between the gasification chamber to the biochar chamber
20. A container for collecting the biochar after biomass has been gasified. It is connected to a hole the bottom of the gasifier chamber allowing biochar and bio-gas out.
30. A small motor
22. A collection chamber of excess bio-gas and to help maintain pressure and store gas for starting the process in between operations.

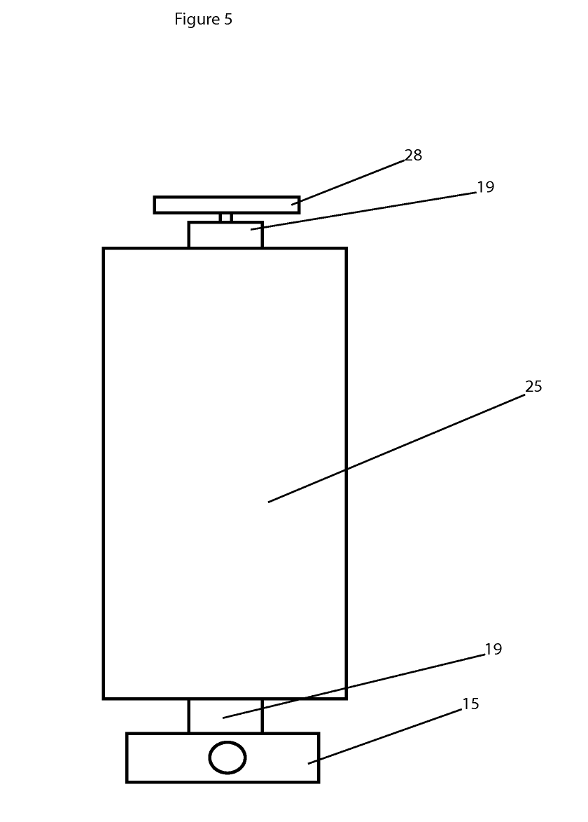

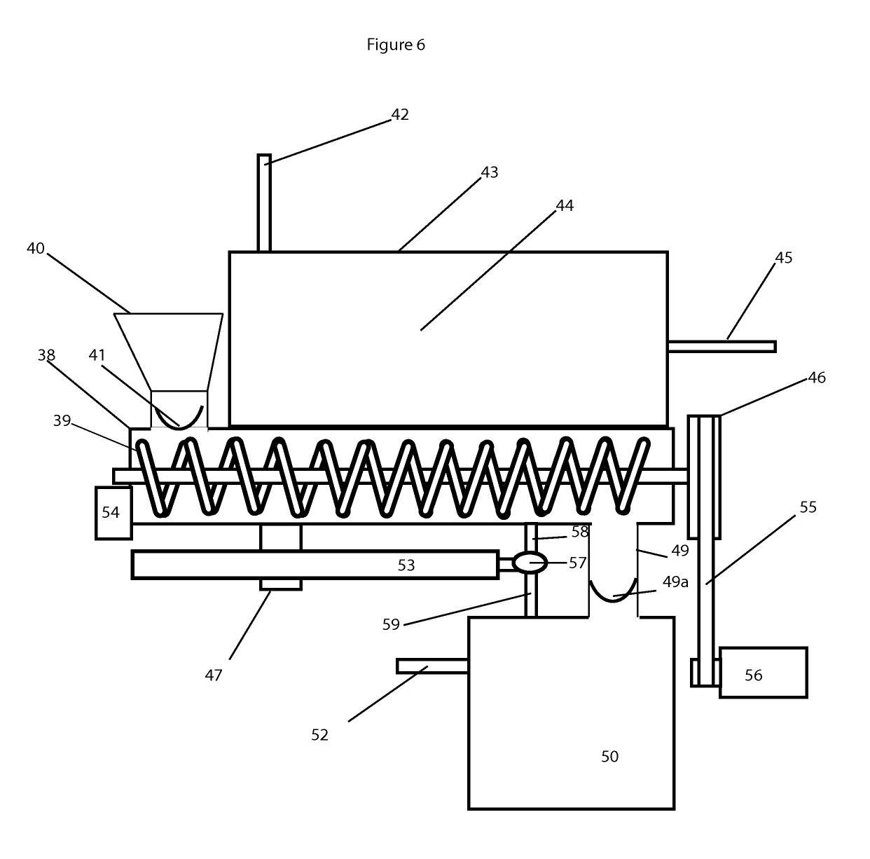

FIG. 5
28. A pulley to move the auger
19. The gasifier chamber is a cylinder made out of metal or other heat conducting materials.
25. A tank made of heat conducting materials is connected to the top of the gasifier chamber allowing heat to flow into the liquid in the tank.
15. Biomass is loaded into a hopper from the crushing roller.

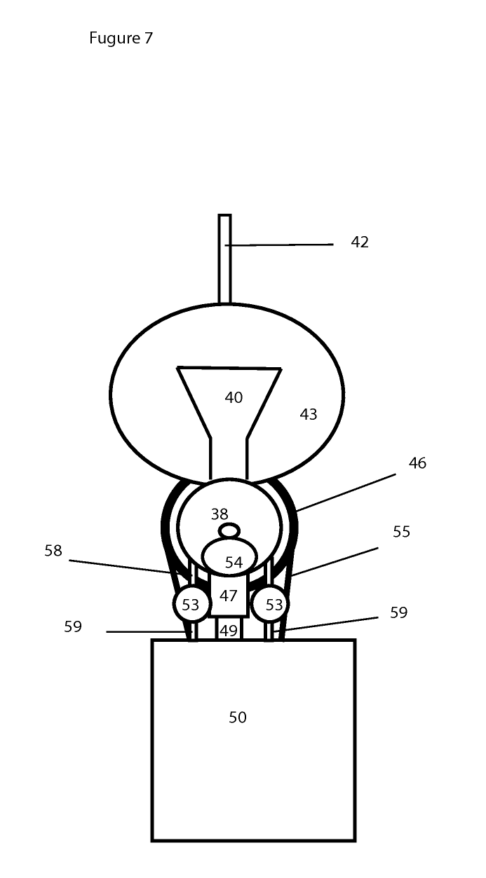

FIG. 6. Micro Combustion System
A micro combustion system can be used if excess energy is not required for storage or other use.
38. Combustion chamber is a cylinder that is made out of a heat conducting materials.
39. Auger to move the fuel through the cylinder
40. Hopper to move fuel into cylinder
41. Valve to allow flow for fuel in and to stop the backflow of combustion into hopper.
42. Tube for return of working liquid from cooling chamber
43. Working liquid heating tank
44. Working Azo compound liquid.
45. Out flow for Azo compound liquid to cooling chamber
46. Pulley to turn auger.
47. Fire ignition device
48. Valve to stop flow of O2 in to ash chamber and flow of Nitrogen gas in to combustion chamber
49. Connection from combustion chamber to ash chamber
49a. Valve in Connection from combustion chamber to ash chamber to allow flow of ash and prevent backflow of nitrogen from ash chamber to combustion chamber
50. Ash chamber
51. Tube carry water from dewater to ash chamber to insure the ash with will no longer combust
52. Tube and valve for the flow of high pressure high concentration oxygen to the combustion chamber and lower pressure high concentration Nitrogen gas to the ash chamber
53. Micro oxygen concentrators
54. Fan with the flow out to pull high oxygen though combustion chamber.
55. Belt to turn auger pulley
56. Small motor
57. High low flow Valve
58. High pressure, high concentration oxygen
59. Low pressure, high concentration Nitrogen

FIG. 7
38. Combustion chamber is a cylinder that is made out of a heat conducting materials
40. Hopper to move fuel into combustion chamber
42. Tube for return of working liquid from cooling chamber
43. Working liquid heating tank
44. Working Azo compound liquid.
46. Pulley to turn auger.
47. Fire ignition device
49. Connection from combustion chamber to ash chamber
50. Ash chamber
52. Tube and valve for the flow of high pressure high concentration oxygen to the combustion chamber and lower pressure high concentration Nitrogen gas to the ash chamber
53. Micro oxygen concentrators
54. Fan with the flow out to pull high O2 though combustion chamber.
55. Belt to turn auger pulley
57. High low flow Valve
58. High pressure, high concentration oxygen
59. Low pressure, high concentration Nitrogen

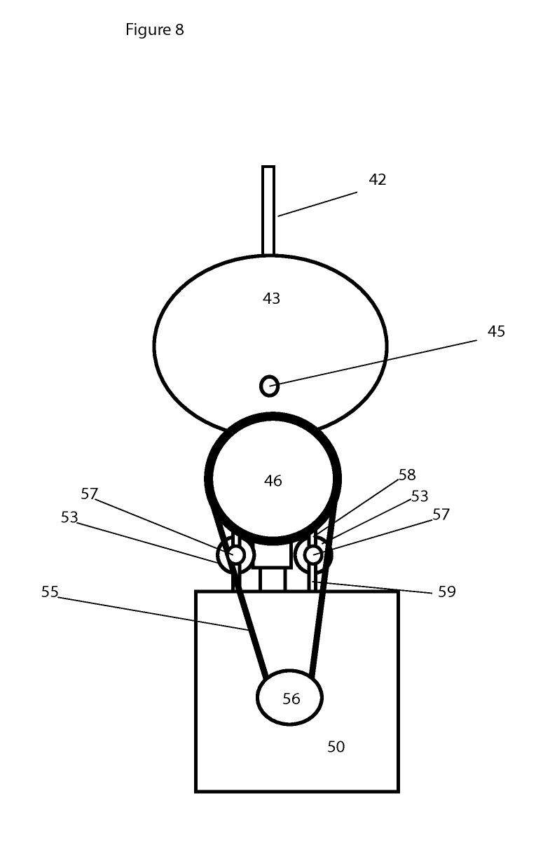

FIG. 8
38. Combustion chamber is a cylinder that is made out of a heat conducting materials
42. Tube for return of working liquid from cooling chamber
43. Working liquid heating tank
44. Working Azo compound liquid.
45. Out flow of Azo compound liquid to cooling chamber
46. Pulley to turn auger.
47. Fire ignition device
48. Valve to stop flow of oxygen in to ash chamber and flow of Nitrogen gas in to combustion chamber
49. Connection from combustion chamber to ash chamber
50. Ash chamber
51. Tube carry water from dewater to ash chamber to insure the ash with will no longer combust
52. Tube and valve for the flow of high pressure high concentration oxygen to the combustion chamber and lower pressure high concentration Nitrogen gas to the ash chamber
53. Micro oxygen concentrators
55. Belt to turn auger pulley
56. Small motor
57. High low flow valve
58. High pressure, high concentration oxygen
59. Low pressure, high concentration Nitrogen

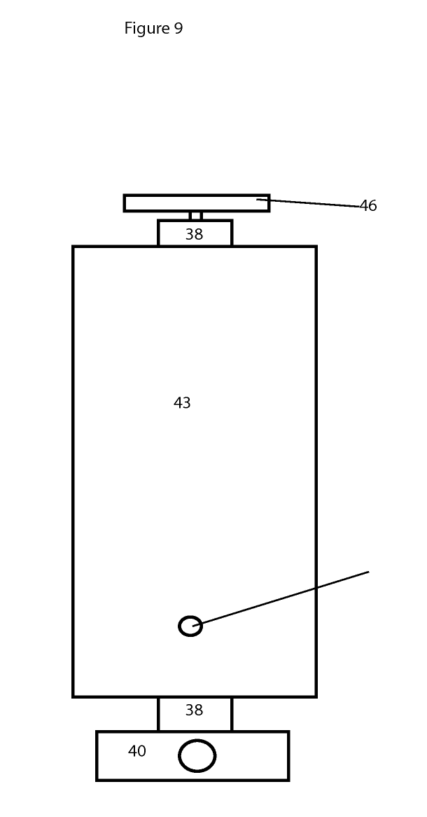

FIG. 9
38. Combustion chamber is a cylinder that is made out of a heat conducting materials
40. Hopper to move fuel into combustion chamber
42. Tube for return of working liquid from cooling chamber
43. Working liquid heating tank
46. Pulley to turn auger.

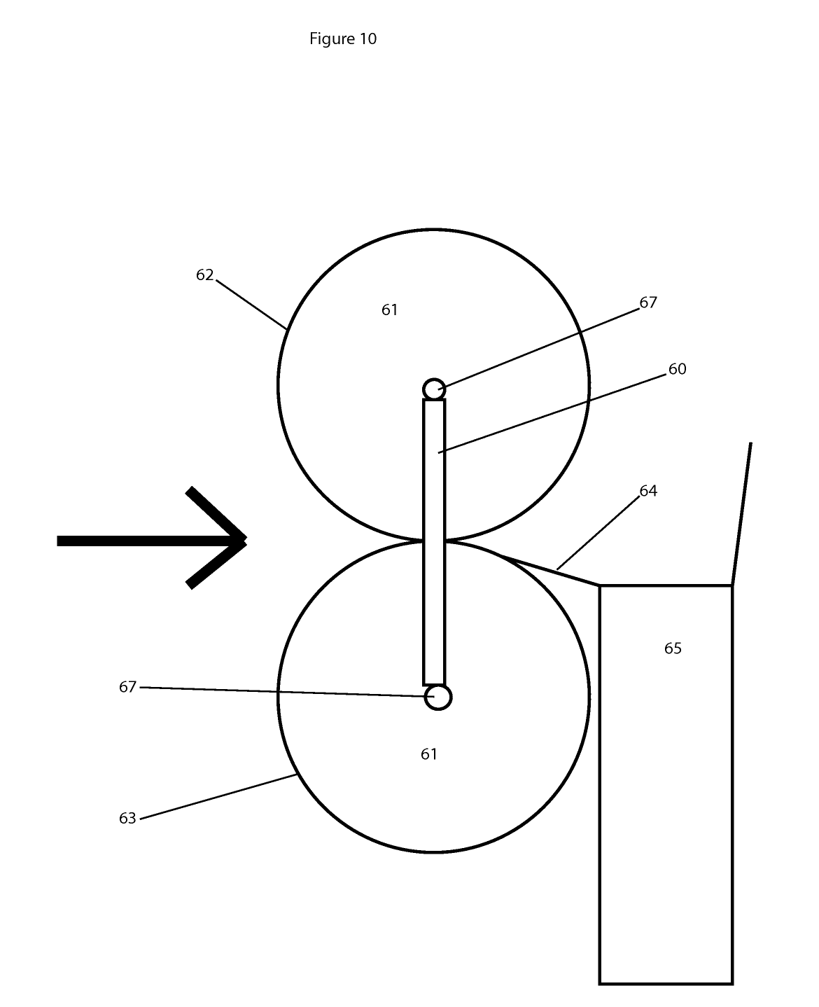

FIG. 10 Food Crusher & Dewater
60. A spring will be used to keep pressure on the materials. This will also allow variation in the size of the materials.
61. Two rollers are used to crush the plant or animal matter to break the cell members allowing water to flow out.
62. The top roller will be coated with a hydrophobic material helping to push the water out of the food.
63. The bottom roller is coated with a hydrophilic material to attract water.
64. A metal scraper will be close but not touching the bottom roller to remove material.
65. Food container to hold crushed and dewatered materials to feed into hopper of micro gasifier
67. Rod that the roller turns on.

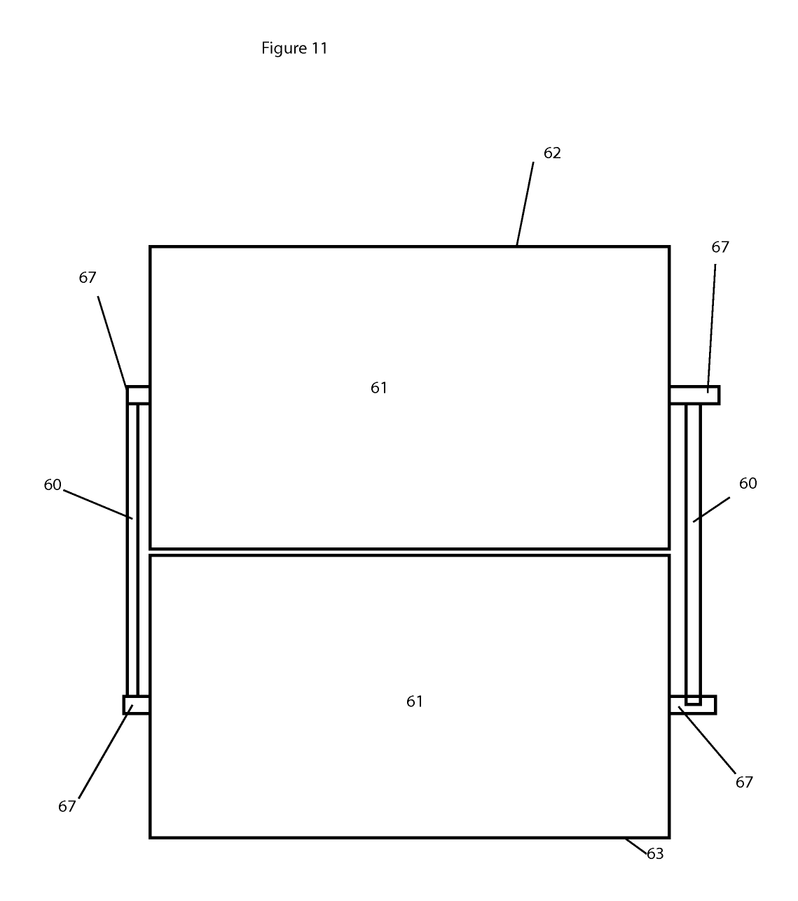

FIG. 11
60. A spring will be used to keep pressure on the materials. This will also allow variation in the size of the materials.
61. Two rollers are used to crush the plant or animal matter to break the cell members allowing water to flow out.
62. The top roller will be coated with a hydrophobic material helping to push the water out of the food.
63. The bottom roller is coated with a hydrophilic material to attract water.
67. Rod that the roller held on.

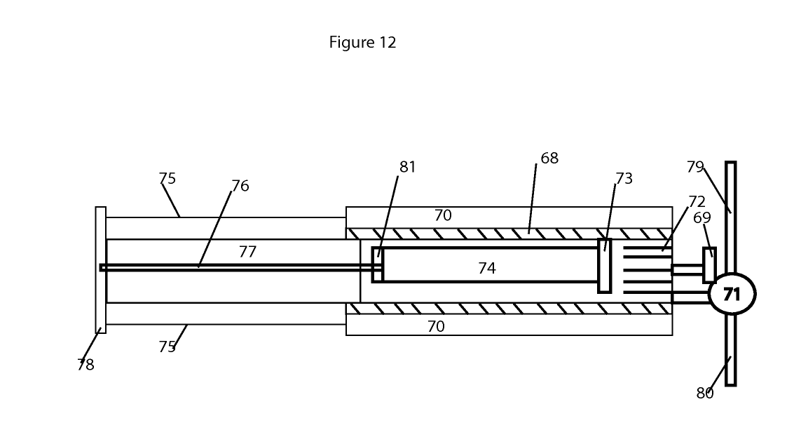

FIG. 12. Micro Oxygen Concentrator
The micro oxygen concentrator will use pressure swing adsorption to filter out nitrogen leaving a high concentration for oxygen to be use in the combustion chamber. Theses will allow the combustion of material that would not burn a normal atmospheric concentration of oxygen.
68. Lower plunger receiver body.
69. Valve will allow flow of air into lower plunger receiver body.
70. Nitinol muscle
71. A valve that allow high pressure flow in one direction and low pressure flow in the other
72. Pressure swing adsorption resin
73. Spring anchor
74. Compression spring. The spring will return plunger to open position after the Nitinol muscles have relaxed and also stretch the Nitinol back out for the next contraction. The air valve will allow air flow back into the cylinder for the next cycle.
75. A steal wire tendon
76. A push rod to compress the spring
77. The plunger to compress the air in the cylinder.
78. A Rim on top of plunger that provides connections of wire tendons to Nitinol muscles and push rods
79. Tube for high pressure high concentrating oxygen to combustion chamber
80. Tube for low pressure high concentration Nitrogen to ash chamber
81. Push rod guide

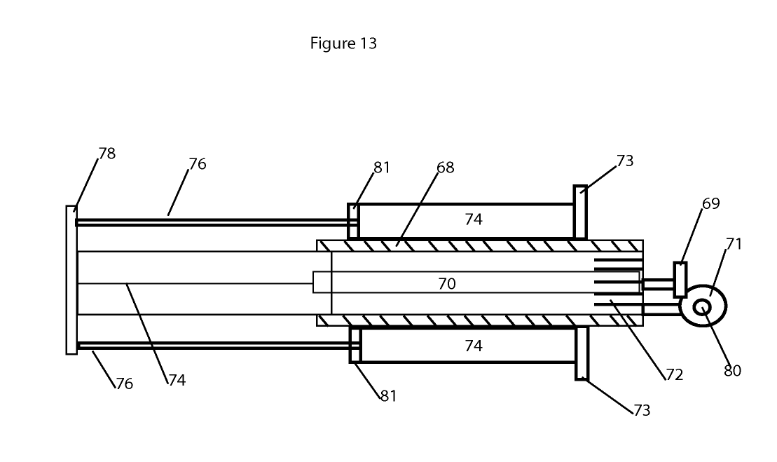

FIG. 13
68. Lower plunger receiver body.
69. Valve will allow flow of air into lower plunger receiver body.
70. Nitinol muscle
71. A valve that allow high pressure flow in one direction and low pressure flow in the other
72. Pressure swing adsorption resin
73. Spring anchor
74. Compression spring. The spring will return plunger to open position after the Nitinol muscles have relaxed and stretch the Nitinol back out for the next contraction. The air valve will allow air flow back into the cylinder for the next cycle.
75. A steal wire tendon
76. A push rod to compress the spring
77. The plunger to compress the air in the cylinder.
78. A rim on top of plunger that provides connections of wire tendons to Nitinol muscles and push rods
80. Tube for low pressure high concentration Nitrogen to ash chamber
81. Push rod guide

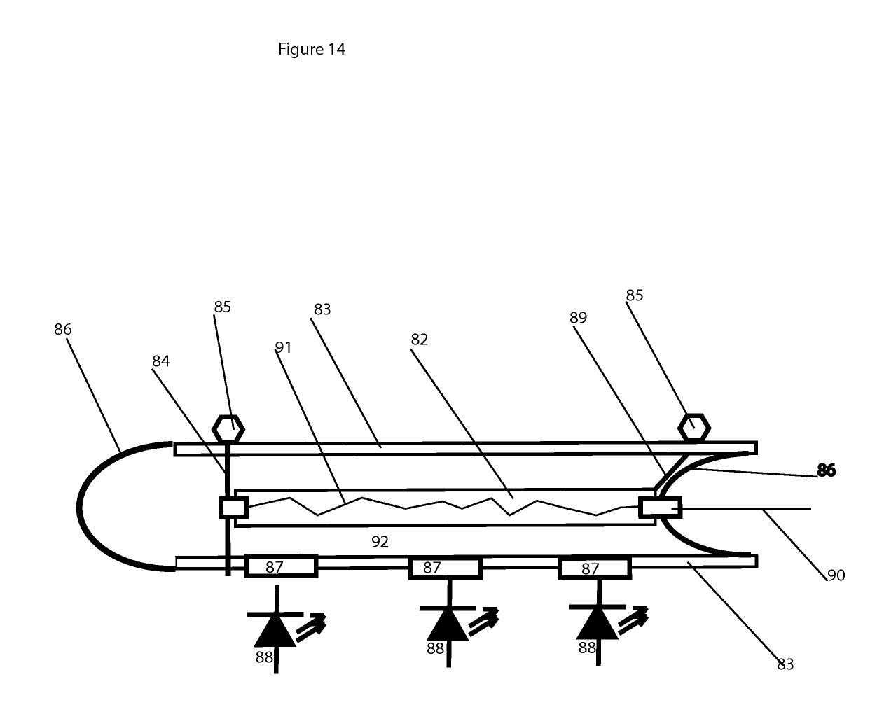

FIG. 14. Internal Heat Nitinol Muscle System
82. A Nitinol spring
83. A cylinder capable of handling the heat of transition of the Nitinol. Transition temperature depends on the nickel titanium ratio in the metal.
84. A metal bar providing a mechanical as well an electrical contention to the spring
85. An electrical connection for passing electrical current through the spring heating it causing to contract to its formed memory shape.
86. A rubber flexible material on both end of the tube containing the spring. The rubber ends allow a contain volume of liquid as the spring is stretched and contracted.
87. Transparent window to allow the light form the LEDs to enter.
88. Led's used to force the chemical equilibrium to the cooling phase
89. Wire to connect the moving end of the spring for an electrical connection.
90. The connecting tendon to the opposing muscle
91. A steal wire runs through the center of the spring to prevent over extension of the Nitinol beyond it recovery length.
92. Azo compound liquid

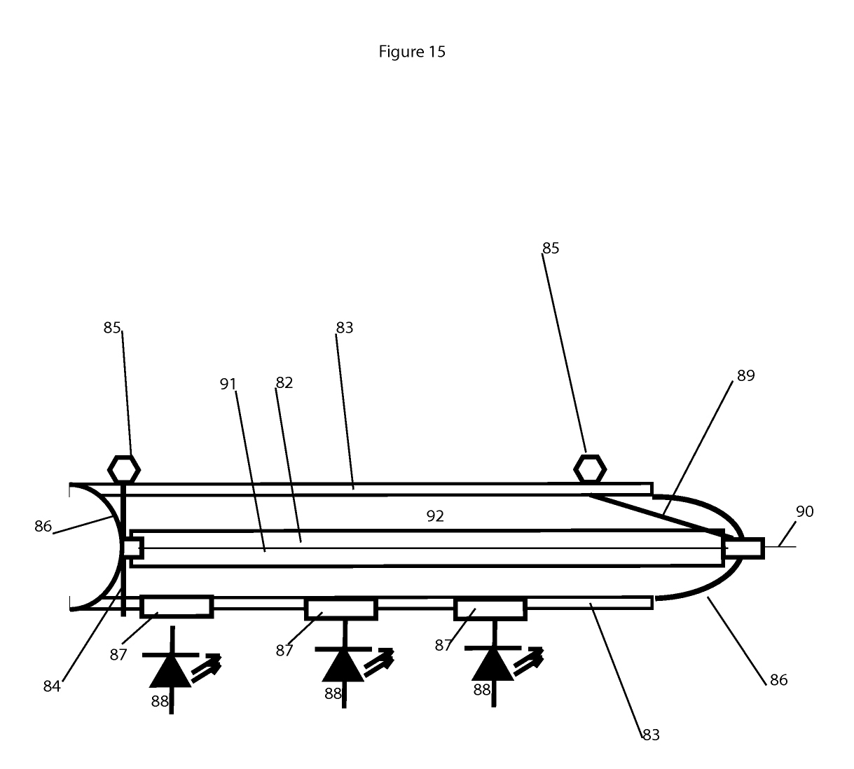

FIG. 15. Internal Heat Nitinol Muscle System
82. A Nitinol spring
83. A cylinder capable of handling the heat of transition of the Nitinol. Transition temperature depends on the nickel titanium ratio in the metal.
84. A metal bar providing a mechanical as well an electrical contention to the spring
85. An electrical connection for passing electrical current through the spring heating it causing to contract to it formed memory shape.
86. A rubber flexible material on both end of the tube containing the spring. The rubber ends allow a contain volume of liquid as the spring is stretched and contracted.
87. Transparent window to allow the light form the LEDs to enter.
88. Led's used to force the chemical equilibrium to the cooling phase
89. Wire to connect the moving end of the spring for an electrical connection.
90. The connecting tendon to the opposing muscle
91. A steal wire runs through the center of the spring to prevent over extension of the Nitinol beyond it recovery length.
92. Azo compound liquid

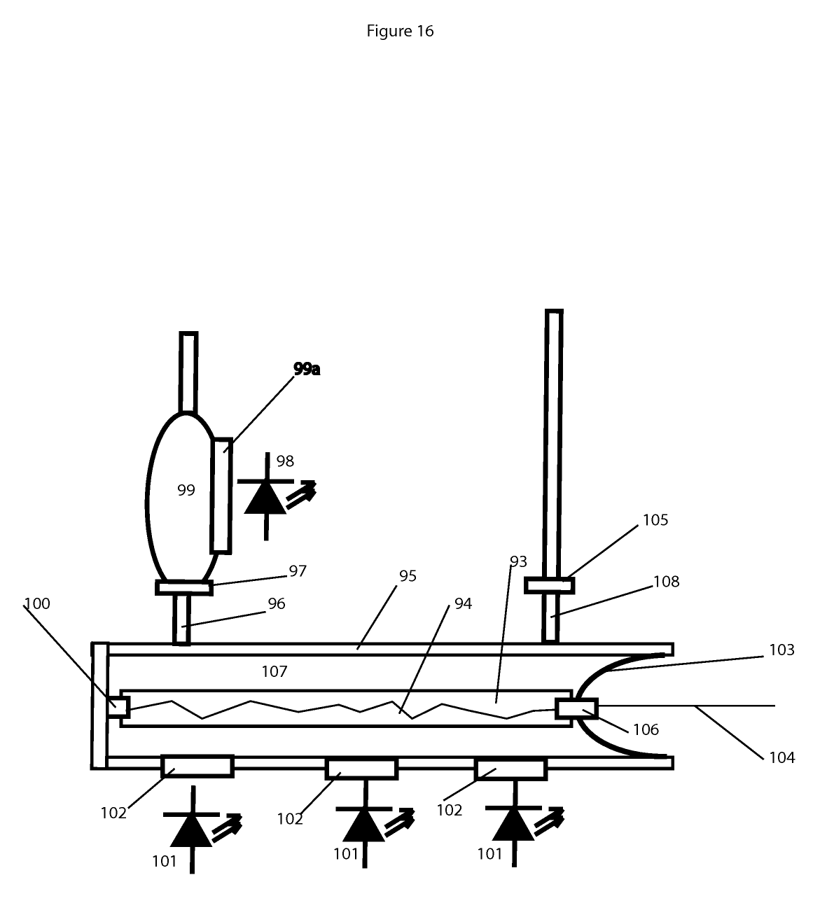

FIG. 16. External Headed Nitinol Muscle
93. A Nitinol spring
94. A steal wire runs through center of the spring to prevent over extension of the Nitinol beyond it recovery length.
95. A cylinder capable of handling the heat of transition of the Nitinol. Transition temperature depends on the nickel titanium ratio in the metal.
96. Intake tube
97. Valve allows only flow into the cylinder
98. LED for per-cooling liquid
99. Pre-cooling chamber.
99a. Transparent window for light to enter Pre-cooling chamber
100. Connection of spring to internal end of spring chamber
101. LEDS to cool liquid in spring chamber
102. Transparent window for light to enter spring chamber
103. Rubber end to keep liquid in spring chamber during screeching and contracting.
104. Tendon to other muscle.
105. Out flow valve.
106. Connector
107. Azo compound liquid
108. Out flow tube

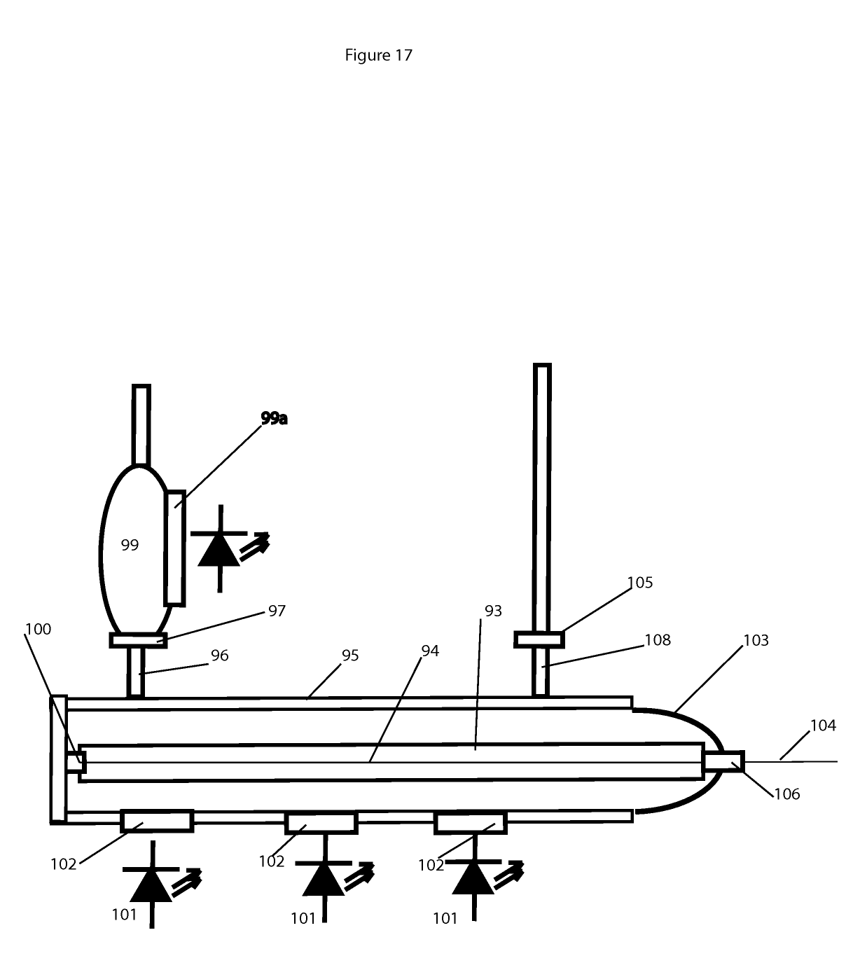

FIG. 17
93. A Nitinol spring
94. A steal wire runs through center of the spring to prevent over extension of the Nitinol beyond it recovery length.
95. A cylinder capable of handling the heat of transition of the Nitinol. The transition temperature depends on the nickel titanium ratio in the metal.
96. Intake tube
97. Valve allow only flow into the cylinder
98. LED for per-cooling liquid
99. Pre-cooling chamber.
99a. Transparent window for light to enter Pre-cooling chamber
100. Connection of spring to internal end of spring chamber
101. LEDS to cool liquid in spring chamber
102. Transparent window for light to enter spring chamber
103. Rubber end to keep liquid in spring chamber during screeching and contracting.
104. Tendon to other muscle.
105. Out flow valve.
106. connector
107. Azo compound liquid
108. Out flow tube

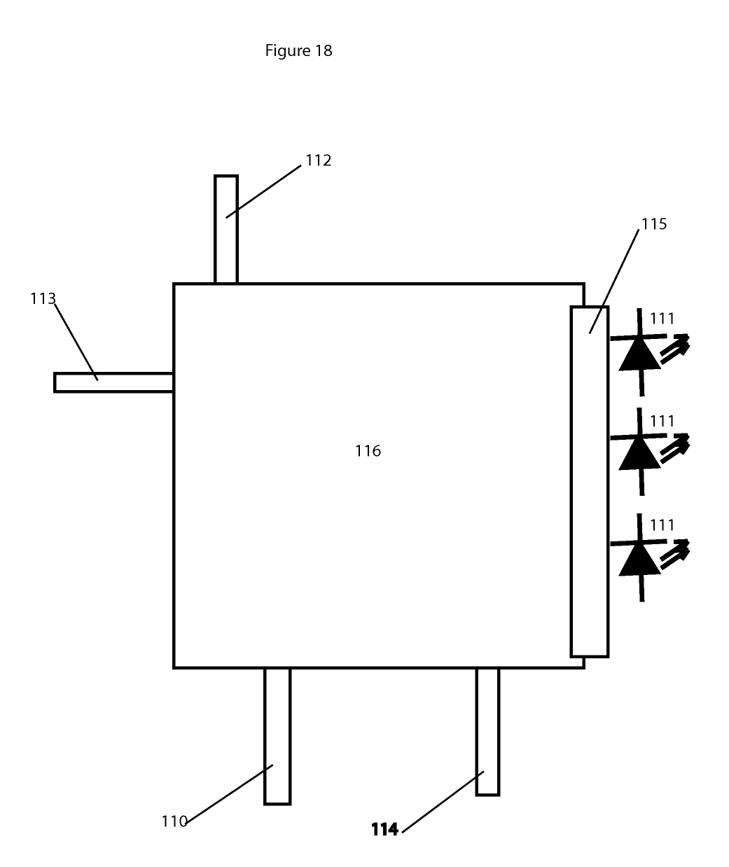

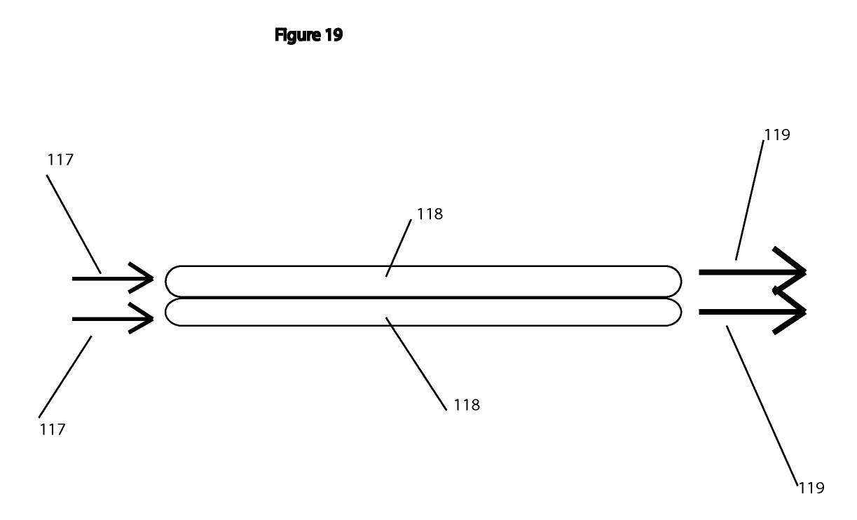

FIG. 18
109. The optical cool chamber uses light to force the cis-trans equilibrium to cis and absorbing the heat and cooling the liquid. The heat is now stored a chemical energy for uses in the Nitinol muscles.
110. Tube use for liquid flow to the muscles.
111. LEDs in the light frequency needed to shift the chemical equilibrium.
112. Tube to move over flow back to heating chamber.
113. Tube to move flow from heating chamber
114. Tube use for liquid flow from muscles
115. Transparent window for light from LEDs to react with liquid
116. Cooling tank

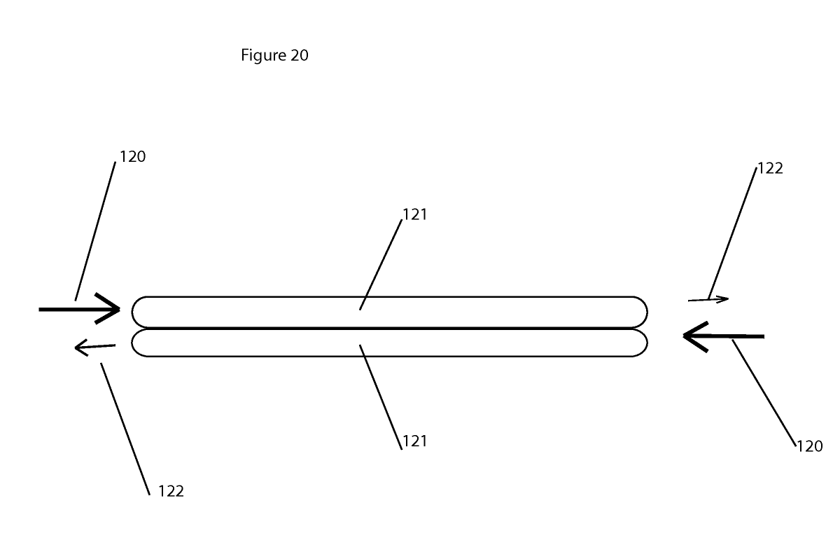

FIG. 19.
117. Signal input into Semiconducting polymer threads
118. Semiconducting polymer threads touching
119. Signal larger output of Semiconducting polymer threads

FIG. 20.
120. Signal input into Semiconducting polymer threads
121. Semiconducting polymer threads touching
122. Signal larger output of Semiconducting polymer threads

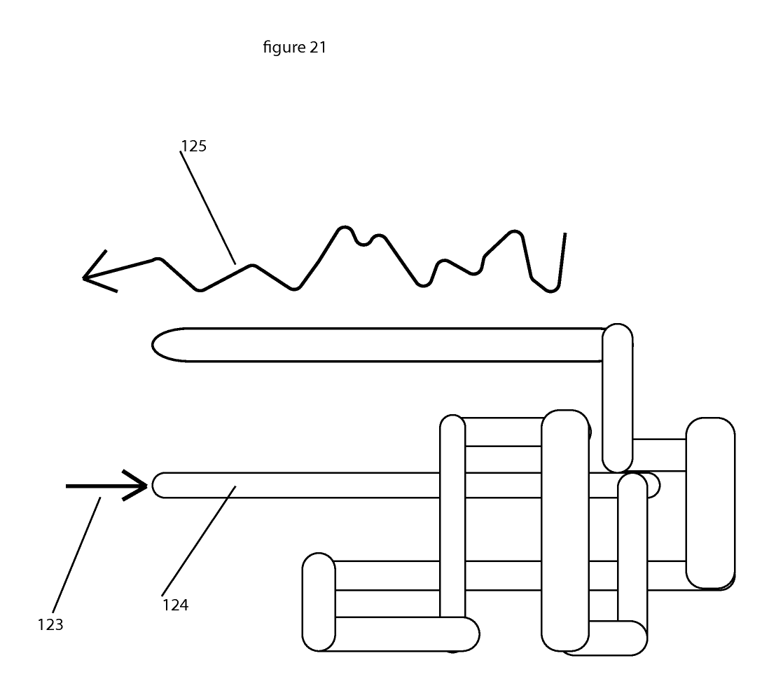

FIG. 21.
123. Signal input into Semiconducting polymer threads
124. Semiconducting polymer threads folded back upon itself touching at differing orientations
125. Modified Output signal

### DETAILED DESCRIPTION AND BEST MODE OF IMPLEMENTATION

An artificial predator can exist in multiple configurations. The subsystems can be contained within one body like a single animal or divided up among members via a hive/swarm design. The system need not even be mobile. Systems can be designed attractive target pests to itself like a Venus flytrap or pitcher plant and deriving power form the pest consumption.

### Uses for an Artificial Predator:

1 Large scale agriculture has become plagued by herbicide resistant weeds and pesticide resistant pests. Due to the introduction for genetically modified crops, weeds and insects have become more resistant because of an evolutionary adaptation to the herbicides and pesticides designed to destroy them. This has happened faster than anyone ever imagined.
2 The large scale travel of persons and freight has led to the major problem of invasive species of plants and animals. Controlling these invasive species has been problematic and expensive. Large scale use of herbicides and pesticides are undesirable, dangerous, and can lead to adaptation and or other unseen environmental concerns.
3 Because invasive species have no natural predators in their new environment; they spread uncontrollably. In the past, when natural predators have been introduced to environments, they have had disastrous results with unforeseen consequences.
4 An AP (artificial predator) can be configured to a specific target, designated area, and or for a specified period of time.

### Subsystems:

Recognition: The recognition system is used to detect the target of the AP from the surrounding environment. A combination of point clouds and 3D sensors will be used to map the surrounding area. 3D simulation will be used to train the neural nets on the recognition of the point clouds.
Alternative-Behavior processing mechanism: (semiconducting polymer thread network) Most system use hardwired or simulated neural nets to produce lifelike behavior. The difficulty of building or simulating Neural Net system grows exponentially with the number of neural and connects in the network. If you view neural nets as just surface chemistry happen in a fixed structure it will be possible to use semiconducting polymer threads to build a structure to product a set of behaviors corresponding to a set inputs. The thread can carrier any electrical signal. When that thread is folded back on itself the contacting surfaces will modify the signal. Therefore the resulting signal will be a result of the knotting or folding of the thread. As a single thread of yarn can be crocheted or knitted into a large number of patterns, a single thread of semiconducting polymer and be folded in to a pattern that produces a unique behavior in response to a unique input. Simulation and evolutionary algorithms can be use to work thought the large possible combination for possible knotting patterns and the behavior of these patterns. The semiconducting polymer threads will be processing information all along its length and feeding back on itself. This method of parallel processing of information can be used to replace more difficult to built neural net hardware and would be fast them software simulated neural nets.
Training System: A combination of supervised and unsupervised learning will be used in conjunction with evolutionary algorithms to build a behavior neural net. This Neural net may be hardware or software or a combination of both depending of the current state of art. To kick start the evolutionary process a set of progenitor neural net with be derived for human player in a 3d simulation of robot behavior. The human player will complete a tack in the game and then the player input will be map to robot outputs and a neural net back calculated to simulate this mappings. These neural net the will be placed in an evolution simulation to compete and combine to build the best fit neural net to the task.
Digestion: Energy will be harvested from the environment by use or a gasifier. The gasifier is designed to take in green plant life, fat, and proteins as feed material.
   1) The MG (Micro Gasifier) will have to have to chew or crush the material in order to break the cell membranes allowing moisture loss. To help remove water for the material to aid gasification. One roller will be covered with a hydrophobic material, the other roller with a hydrophilic material. After breaking down the materials, they will transported by an auger mechanism. It will then heated by the gas from the gasification process. The feed material heated in a low oxygen environment will decompose into flammable gases. These gases will go into a splitter where a portion of the gas will be returned to continue the reaction process. The rest will go into the energy conversion device. An oxygen concentrator can be used to increase the temperature of the reactions.
   Energy Conversion:
Several energy conversion devices can be used at this stage. It will depend on the energy demands, the space available, and weight consideration.
   Nitinol muscles with Azo compound heat storage, Sterling engines, internal combustion engines, fuel-cells, and cyclone engines (U.S. Pat. No. 7,080,512 B2), or MDH generator are possible candidates for energy conversion.
The ash for gasification is commonly referred to as Biochar. It can be sold as a high valued fertilizer. The Biochar can be returned to the field to reduce the cost of fertilizers or harvested as a secondary product for sale. Another market for the AP technology would be using the robots to harvest open fields of grass to produce fuel for energy production and Biochar for fertilizer.

Possible Robot Configurations:

The Self-Contained

The Hive Configuration

The Mobile Hive Configurations

Examples of HRBs (Herbicide Replacement Robots)
HRB will be designed to replace herbicides for weed control on large farms that presently use air sprayed herbicides. The robot will be tied into cloud-based software as a service system for field management and recognition services. The robot will only need to differentiate between plants and weeds, so that plants will not to be picked. All other plants in the field will be picked and their roots will be destroyed and/or consumed for fuel.

Example of PRBs (Pesticide Replacement Robots)
PRD will be designed to target insect pests. The recognition system will be cloud-based. The recognition needs to be able to recognize good and bad bugs. This will be done through a combination of neural nets, point-clouds, and probability algorithms. The plant releases compounds to attract beneficial insects if they are under attack from pests. A combination of a full spectrum camera and a tunable (adaptable) light source can be used to detect these compounds.
The gasification system of the pest control robot will need to be configured to deal with the gasification for proteins and fats, instead of plant materials.

Example of ISHR_Ps (Invasive Hunter Robots for Plants)
ISHR_P will need to be able to detect the target plant to destroy it. It will need to be configured to carry all its needed onboard processing. Unlike the HRB and PRD that operates in a defined area, the ISHR_P may not be able to get a dependable uplink. The ISHR_P will need to be programmed to avoid humans to avoid responding to a person not familiar with the robot to prevent theft or damage. A long range radio link can be used to recall it to a predefined location.

Example of ISHR_A (Invasive Hunter Robots for Animals)
The ISHR_A will need to be designed to be physically more agile and with faster recognition. Plants are static target while pest are mobile targets. Motion alone we not be sufficient for targeting. The robot will need to not target useful insects like pollinators.
It won't be necessary need to destroy all the pests in an area. Hunting pressure will make other areas more attractive than the area patrolled by the ISHR_A. Pests will migrate away for the area you what to protect:

Example of FHRs (Forest Husbandry Robots)
FHRs are similar to the ISHR_Ps except it will target all plants in a particular overgrown or dead condition instead of a specific plant. Controlled burns are used in the reduction of over growth and dead underbrush. Occasionally, they are a major contributor to deadly forest fires. FHR will thin the underbrush and dead material safely. It will return the Biochar to the forest floor much like a natural occurring fire but without the danger to life and property.

Example of EFRs (Energy Farming Robots)
EFRs are similar to a FHR but are equipped with a larger fuel store capacity and the ability to offload the fuel to storage when needed.

Example of BFRs (Biochar Farming Robots)
BFRs have a large store area for Biochar and return to offload to a storage container when full.

Example of SMRs (Septic Maintenance Robots)
SMR are powered from patented microbial fuel cells (U.S. Pat. No. 4,652,501 A). (http://www.engr.psu.edu/ce/enve/logan/bioenergy/mfc_patents.htm). They are designed to move around a septic system breaking down solids to where they can be mixed into the septic system with its motion. Using the microbial fuel cell, it is designed not to be retrieved from the system. The SMR will extend the life of the septic system.

Example of NMVDRs (Nonlethal Mercerized Military Vehicle Deterrent Robots)

The NMVDRs are small ant like robots are dropped into an area. They will scan for a heat source like the hot engine of vehicle like a tank and trucks. All engines need air to run and access for repairs which make these vehicles. These design constrains will make all motor transport vulnerable to attack by small robots. They can chew through wires and hoses and disable the engine. Humans will not be hot enough to get the same response. They can be placed in the path of an oncoming military force to slow them without causing casualties. They may be dropped behind enemy lines, causing havoc to power systems and communications equipment.

Example of NON-Mobile Artificial Predator
A non-mobile artificial predator can attract pest like ticks with CO2 heat and color then crush and digest the tick to product more co2 and heat. Device like this can be place in tree and bush to reduce the tick population without the use of pesticides.

Example of CARs (Composting Assistant Robots)
Most waste treatment plants have moved to composting solids remaining from sewerage treatment. Large piles of solids are allowed to compost while covered. These piles have to be turned on regular basics. This requires them to be uncovered and moved with large equipment. This creates odor problems for neighboring communities. Small thermo-power robots can move through the piles without uncovering them solving the odor problem. The motion will mix the piles to aid in the decomposition process. The heat from this decomposition process can power the Nitinol muscle pairs. It will evenly mix the compost, by moving in the direction of the largest heat source.
Muscles: Nitinol (U.S. Pat. No. 6,422,010 B1) is a shape memory metal which can be used to replace motors in robot design. The metal will return to a set shape when heated above a threshold temperature and bend again when the metal is below that temperature. This is done with much less mechanical force. Although Nitinol delivers excellent power to weight ratio, its mechanical conversion of electrical power is very poor. This due to the fact that the heat has to be removed before the next contraction is the metal can be stretched. This causes poor efficiency in the overall cycle. To compensate for this, the device must carry heavy batteries. Nitinol can also be activated by heat. To solve this problem a reversible endothermic/exothermic chemical reaction in equilibrium is to store energy between cycles of the Nitinol. The exothermic phase will heat the metal causes it to contract. The endothermic phase can cool the metal, allowing it to be flexed by another device, much like the muscles in our body contract. The energy for these “muscles” can be produced by excess heat from the gasification process. The control system that will cause the equilibrium to shift between phases will be a frequency of light tuned to necessary bond lengths. This will allow conversion of heat from a fuel source (biogas from gasification) to be converted to mechanical motion while not relying on the universal gas law.
A possible configuration would be a hive setup. Small robots can move throughout the environment, bringing food, (weeds and other biological waste), back to the hive where it is gasified. These materials are converted into electricity and heat, powering the robots. This power can be absorbed by the robot into an endothermic state which stores the energy for exothermic use in the muscles.
Muscles to generate electric power by mechanical motion: A Nitinol muscle pair can be used to move a magnet inside a coil of wire like a linear generator. Smaller robots can use this to power their electrical components. This heat can be derived from a fuel or from another external heat source. The will replace need for a battery.
A thermodynamic equilibrium between Cis- and Trans-isomers can be controlled by a UV light tuned to the wavelength equal to length of the carbon bond or double nitrogen bonds which we wish to activate. The Azo family of compounds is and excellent candidate for a controlled Cis- and Trans-isomers heat storage. This can be used to quickly store heat as chemical energy and access the heat between cycles of the Nitinol muscle pair. The speed of the conversion from state to the other is controlled by the concentration of salts to make a polar solution.
Azo compounds are compounds bearing the functional group R—N═N—R′, in which R and R′ can be either aryl or alkyl. IUPAC defines azo compounds as: “Derivatives of diazene (diimide), HN═NH, wherein both hydrogens are substituted by hydrocarbyl groups, e.g. PhN═NPh azobenzene or diphenyldiazene.”^{[1]} The more stable derivatives contain two aryl groups. The N═N group is called an azo group. The name azo comes from azote, the French name for nitrogen that is derived from the Greek a (not)+zoe (to live).

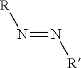

Application for the Muscles to Generate Electric Power (MGEP)

1,) Using the excess heat from the internal combustion engine in a hybrid car to generate electricity. Half the energy in the gasoline is wasted as heat in an internal combustion engine. Recapturing this energy can double the mileages of the car.

2,) Using the excess heat from a firearm to power scopes and night vision equipment. Also using the heat will cool the firearm giving at a reduced thermal signature in inferred images.

Full spectrum Imaging:

A full spectrum camera utilized together with a tunable controllable full spectrum light source can be used to detect chemicals in the environment. It can transmit differentiating images into the front end of a neural network. Many plants give off chemical signatures when under attack by insects.

Microbial Thermo-Cell:

The Nitinol muscles can run off heat from a biological reaction caused by like microbes eating plant, proteins or fats. Anyone who has composted plants from a garden knows that aerobic bacteria will produce heat while decomposing organic material. A digestive system can be constructed using live bacteria to produce heat to power a Nitinol powered robot.

The Microbial thermo-cell can be integrated into an individual robot or be contained within a mobile or stationary hive system.

SELF-Powered Hot Water Pump:

Using a heat powered Nitinol Muscle pair, it would be possible to construct a hot water pump which runs off of the heat in the water.

### REFERENCES

### Aspects AP

1) An artificial predator will return balance in ecological system.
2) An artificial predator can operate for long periods of time without being recharges.
3) An artificial Predator will not need to replace or recharge batteries.
4) An artificial predator can reduced the population for harmful insects (ticks, fire-ants, termites) without pesticides.
5) By consuming a target species it will rebalance the environment in which it exists.
6) The artificial predator will derive energy from the target consumed.
7) An AP will stay in the area it has been assigned to.
8) An AP will not interact with another species not assigned to it.
9) The AP will avoid humans for safety and security reasons.
10) The AP can replace herbicides and pesticides in large-scale agriculture environments.
11) An AP can prevent damage to environments and properties by pests and/or any other invasive species.
12) An AP can harvest energy from the environment for human needs as well as its own power structure, all while protecting the natural environment.
13) An AP can stop the evolutionary adaption of plants and pests to herbicides and pesticides.

### Aspects Micro Gasifier (MG)

1,) A MG will allow robots to operate for long periods of time with minimal interruptions for fuel or battery recharge.
2,) A MG will allow the destruction of target organisms.
3,) A MG will return nutrients back to the environment just like fire does to a forest.
4,) A MG will be able to energy beyond the direct needs of a robot of other uses.
5,) A MG can be use to collect energy for parks and forests at a rate that would allow them to still be used as park and forest while product power for other human uses.
6 A MG can be user to return nutrients to the soil

### Aspects: Micro Combustion System (MC):

1. A Micro Combustion can be use where use of energy outside the robot is not needed.
2. A MC will allow robots to operate for long periods of time with minimal interruptions for fuel or battery recharge.
3. A MC will allow the destruction of target organisms.
4. A MC will return nutrients back to the environment just like fire does to a forest.

### Aspects: Micro Oxygen Concentrator (MOC)

1. Micro oxygen concentrator will enable a GC to run hotter to convert tar in biomass
2. MOC can run solely of the heat from a CG or MC
3. MOC can run solely on electricity depending on the configuration of the Nitinol muscles
4. MOC can product concentrated oxygen to increases combustion and concentrated Nitrogen to deter combustion.

### Aspects Nitinol Muscles Pair Thermodynamic Storage (NMP_TS).

1,) An NMP_T has thermodynamic storage able to increase the energy efficiency of the Nitinol muscles pair by storing energy between cycles.
2,) An NMP_TS uses excess heat from the MG to power a legged robot.
3,) An NMP_TS can power a robot with a combustible renewable fuel source instead of batteries.
4,) NMP_TS will be able to move a magnet within a coil to provide electrical power to electronics.
5,) NMP_TS will make it possible to build very small robots efficiently without the need for heavy motors and heavy batteries.

### Aspects Nitinol Muscles Pair Thermodynamic Storage (NMP_TS) Internal Heated.

1. The thermodynamic Storage of Azo compound will reduce power requirement of compared to Nitinol.
2. The thermodynamic Storage of Azo compound will increase the speed of cycle time Nitinol Muscles

### Aspects Nitinol Muscles Pair Thermodynamic Storage (NMP_TS) External Heated.

1. With reduce electrical power requirements of a mobile robot.
2. Provide natural like movement.

### Aspects Thermo Power Robot:

1) A thermo power robot can get its power from an external heat source (compost pile) or internal heat source (burning fuel, gasification, microbial thermo unit) to power Nitinol muscles and/or a Nitinol electric generator.
2) The TPR can be very small, possible to the size of an actual ant.
3) These robots can function within pipes to constantly clean and maintain complex systems like power plant sewerage facilities and landfill lechate facilities. It can work with any system that would normally require a shutdown to clean or maintain.

### Aspects Heat Powered Water Pump:

1,) The Heat Powered Water Pump will be able to pump water using the heat energy contained in the water. This pump will be useful for off the grid applications for solar hot water heaters and other heating applications.

### Aspects Muscles to Generate Electric Power (MGEP)

1) Excess heat can be effectually converted to electricity.
2) Lower heat than other engine application can be used.
3) The MGEP would be relatively quite compared to other conversion methods.
4) The MGEP would be more efficient that a Peltier device U.S. Pat. No. 4,470,263 A
5) The MGEP Liquid can be use for rapid cooling and transfer of heat
6) The MGEP will not be limited by the universal gas law like other heat engines.

An artificial predator is a robotic system that does two tasks at the same time by eating

An artificial predator will harvest chemical energy from the environment in which it lives by (eating) a target species. The target species is programmed into the robot. The robot uses neural nets (or similar system) for discerning what to target and what to ignore. Then the robot can convert this food into energy. After this process is completed, the robot will continue to hunt and consume its target species.
The robot would move through the ecosystem, whether it is natural or manmade. It can be trained to attack a specific target. One potential target would be a plant like a weed on a large agricultural farm. Another potential target could be a pest in a farmer's field such as an invasive species of plant or animal. This robot can also be used to detect and destroy pests found in a forest such as the Multiform Rose or longhorn beetle. Once it finds the target; it eats it; converting it to energy the way the digestive system works, converting food into calories. This energy conversion by the robot occurs through several possible methods. There is gasification to flammable fuel. Additionally, this conversion process can also generate electricity for use
   Claims: An Artificial Predator

1. An artificial predator is a robotics system that does two tasks by that same by eating. By eating a desired target it destroys that target and gains energy to continue eating the target without stop to refuel or recharge.

2. The artificial predator may be mobile hunting the target

3. The artificial predator may be immobile attracting the target to it.
Claim: Semiconducting Polymer Thread Network

4. Semiconducting polymer thread networks can process complex information and produce complex lifelike behaviors.
